(19) United States
(12) Patent Application Publication
(10) Pub. No.: US 2010/0149519 A1
(43) Pub. Date: Jun. 17, 2010

(54) POLARIZATION CONTRAST IMAGER (PCI)

(76) Inventor: Mehrdad Toofan, Davis, CA (US)

Correspondence Address: Mehrdad Toofan, 1603 Santa Rosa St., Davis, CA, 95616, US

(21) Appl. No.: 12/481,576

(22) Filed: Jun. 10, 2009

Related U.S. Application Data
(60) Provisional application No. 61/060,815, filed on Jun. 12, 2008.

(51) Int. Cl. G01J 4/04; G01J 3/00; G02B 27/42

(52) U.S. Cl. 356/51; 356/364; 250/550

(57) ABSTRACT

A linearly polarized light is used to probe the detailed structure of a specimen. A reference light is also generated whose amplitude matches the amplitude of the diffracted light from the specimen. The reference light could either be generated from the light source itself as it is reflected off from a mirror through a light attenuator, or could as well be generated off from the reflected/transmitted light from/through the specimen passing through a light attenuator. The light from the specimen is retarded by a quarter-wave with respect to the reference light and the two lights are then passed through another polarizer/analyzer which allows the reference light and the diffracted light from the specimen to pass through while removing the background light. The diffracted light from the specimen, which carries the phase information of the underlying specimen's structure, is modulated by the reference light. The modulation is then recorded on an image sensor such as CCD. Should the specimen have any paramagnetic property, a magnetic gradient generator is employed to accentuate the image details further. The invention thus could be used to diagnosis a disease such as malaria due to paramagnetic and birefringence property of Hemozoin, the malaria pigment.

### CROSS-REFERENCE TO RELATED APPLICATIONS

This application claims the benefit, under 35 U.S.C. § 119, of U.S. Provisional Application Ser. No. 61/060,815, filed on Jun. 12, 2008.

### FIELD OF THE INVENTION

This invention relates to the detection of underlying structure of a specimen using polarized light. In particular it describes a method and system where changes in polarization of incident light shined upon a specimen is used to visualize the detailed structure of the object under study by using a reference light.

### DESCRIPTION OF THE PRIOR ART

Although there are many ways to visualize detailed structures of an object, the most relevant methods comparable to this invention are polarization microscopy, phase contrast microscopy, Orthogonal Polarization Spectral Imaging (OPS), and Sidestream Dark Field Imaging (SDI).

Polarization microscopy is no more than an ordinary microscope equipped with a polarizer before the polarizer, and another polarizer (analyzer) whose optical axis is perpendicular to the axis of the first polarizer. Along the optical path, somewhere between the polarizer and the analyzer, a compensator is placed either before or after the specimen. To get a high extinction factor (EF), to see very minute details of the specimen, a number of conditions are needed to be met concurrently: Lenses, slides, and cover slips are strain free; the light source must be extremely bright and observation preferably needs to be carried out in a darkened area; Koehler illumination must be observed, and optical elements need to be accurately aligned.

In phase polarization microscopy, pioneered in 1934 by Dutch physicist Dr. Fritz Zernike, the minute variations in phase due to light transmission through the specimen is translated into corresponding change in amplitude which then could be visualized accordingly. An iris is placed at the front focal plane of the condenser lens which collimates the light upon the specimen. The light emergent from the transparent specimen passes through the object lens and reaches a phase plate located in the rear focal plane of the objective lens. The phase plate is a flat glass plate which is made of two concentric sections. The central section is a partially absorbing mask which is slightly larger than the conjugate of the pinhole located at the condenser iris. The function of the phase plate is to retard the light through the specimen by a quarter of a wave while reducing the background wave's amplitude enough to match that of light through the specimen. The diffracted light from the specimen thus interferes destructively with the background light to produce the specimen's details.

In Orthogonal Polarization Spectral Imaging (OPS) the specimen is illuminated with a linearly polarized light by passing the light through a polarizer. The polarized light then reflected towards the specimen by a beam splitter. An objective lens focuses the light onto the specimen. The remitted light from the specimen is then collected by the same objective lens and is send through the beam splitter towards another polarizer (analyzer) oriented with its optical axis orthogonal to the first polarizer. The emergent light from the analyzer is then collected by CCD.

In Sidestream Dark Field Imaging (SDI), the specimen is illuminated by a ring of LEDs which are optically isolated from an inner ring hosting an objective lens system. Light from the LED ring penetrate the specimen and then is scattered back through the lens system towards a CCD for further analysis.

### SUMMARY OF THE INVENTION

When light is incident upon a specimen, the phase value of the reflected or transmitted light would change according to the underlying minute structures and shape of the specimen. The foundation for the invention is use a reference light to modulate the intensity of a reflected/transmitted and diffracted light from/through a specimen, wherein the information about the specimen structures is encoded in the phase of the diffracted light and subsequently to record or to visualize the resultant phase contrast image. The invention is termed as Polarization Contrast Imager, or in short PCI. In reflection configuration of PCI, a collimated beam of light generated from a light source passes through a polarizer which is then divided by a beam splitter: Part of it is directed towards and reflected back from the specimen, and the other part is reflected by a mirror (the reference light) while attenuated enough to make its amplitude compatible with that portion of the reflected light from the specimen which carries the phase information. By removing the incident component of the light from the reflected light from the specimen (and thus leaving the phase information carried by diffracted light from the specimen) and combining it with the reference light, a detailed phase contrast image of the underlying structure of the specimen could be observed.

### BRIEF DESCRIPTION OF THE DRAWINGS

FIG. 1 shows principle of operation of the invention where a reference light of appropriate amplitude is used to modulate the polarized reflected light from the specimen.

FIG. 2 shows an alternative embodiment of the invention where a half-a-quarter wave phase retarder has been introduced in the reflection path from the specimen to isolate the light source.

FIG. 3 shows an alternative embodiment of the invention where a half-a-quarter phase retarder is introduced in the reference light path, and a quarter wave phase retarder is used to remove any incident polarized light upon the specimen.

FIG. 4 shows an alternative embodiment of the invention where an analyzer and couple of retarders have been chosen to remove any incident polarized light shined upon the specimen.

FIG. 5 depicts an alternative embodiment of the invention where focusing elements are introduced to focus the light upon the specimen or upon an image sensor.

FIG. 6 shows an alternative embodiment of the invention where a magnetic gradient generator is introduced to attract free paramagnetic cells within the specimen.

FIG. 7 depicts an alternative embodiment of the invention where angle of incident light upon the specimen is different from normal.

FIG. 8 shows an alternative embodiment of the invention where the incident light upon the specimen is oblique and a mirror is used to deflect the light away from the specimen after its first reflection from the specimen.

FIG. 9 depicts an alternative embodiment of the invention where phase retarders are chosen to channel the reference light and the reflected light from the specimen away and then towards each other.

FIG. 10 shows an alternative embodiment of the invention where a magnetic gradient generator as well as appropriate retarders and beam splitters are introduced to generate the reference light.

FIG. 11 shows an alternative embodiment of the invention where the image sensor is aligned with the specimen under investigation, and retarders are placed in critical positions in order to accommodate the change of polarization due to the reflection at the beam splitter interface.

FIG. 12 shows an alternative embodiment of the invention similar to FIG. 11 except that the specimen is not in line with the image sensor.

FIG. 13 shows an alternative embodiment of the invention similar to FIG. 3 except that focusing lens and field gradient generators are also introduced in the design.

FIG. 14 depicts an alternative embodiment of the invention where the reference light has been generated off of light coming back from the specimen instead of directly from the light source.

FIG. 15 shows an alternative embodiment of the invention similar to FIG. 14 where again the reference light is created from the reflected light from the specimen.

FIG. 16 depicts an alternative embodiment of the invention similar to FIG. 14 except that the specimen is in line with the image sensor.

FIG. 17 depicts an alternative embodiment of the invention where instead of generating image from the reflected light from the specimen, the image instead is generated by modulating the light transmitted through the specimen using a reference light.

FIG. 18 depicts an alternative embodiment of the invention similar to FIG. 17 but using a retarder to isolate the light source.

FIG. 19 shows an alternative embodiment of the invention similar to FIG. 17 in which magnetic field gradient generators have been utilized along with an appropriate retarder in critical position in order to accommodate the change of polarization due to the reflection at the beam splitter interface.

### DETAILED DESCRIPTION OF THE INVENTION

The invention describes a method, procedure, and a system for visualizing of minute biological structures. However, it must be noted that the system could as well be used in other applications where one is studying the surface structures of some materials. The invention, Polarization Contrast Imager, referred to from now on as PCI, relies on detection of exceedingly weak birefringence and/or change in polarization of light, due to minute optical path differences exhibited by biological cells, from a reflective/transmission light from/through the specimen. Furthermore, PCI takes advantage of the fact that some of these biological structures exhibit paramagnetism and hence could be used to more accurately identify their presence in the biological entity under investigation.

One of the aims of this invention is to provide a diagnostic mechanism and an investigation tool which is not only convenient to use, but is also reliable, accurate and economical to manufacture. Such requirements are cornerstones in diagnosis of a disease such as malaria. For malaria, PCI, furthermore attempts to provide in vivo diagnostic of the disease without the need to extract and prepare blood samples.

PCI borrows its principle from phase contrast microscopy (pioneered by Noble prize winner, Dr. Fritz Zernike), and polarization microscopy. Furthermore, PCI uses magnetic field gradient in application where the biological cells under study have paramagnetic properties.

Therefore, accurate detection of malaria, for example, is feasible by PCI by taking advantage of the facts that Hemozoin, the malaria pigment, exhibits paramagnetic properties, and has birefringence property.

Today, the most common malaria detection methods rely on either field microscopy or Rapid Diagnostic Test (RDT). While both methods require very careful extraction and elaborate preparation of blood sample from the patient, field microscopy in particular requires very skillful and trained microscopist. In these respects, another major advantage of PCI is in vivo (live) detection of malaria without blood extraction.

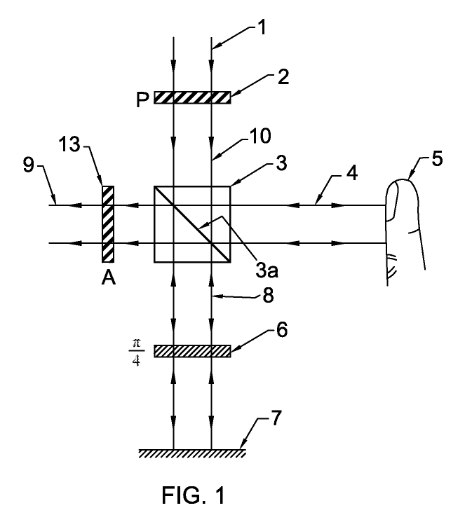

In its simplest form, which conveys the principle of operation, FIG. 1, depicts the underlying structure of PCI. A collimated beam of light 1, passes through a polarizer 2 whose axis is set at 45 degrees. The emergent light 10 from the polarizer 2 then impinges on a beam splitter 3 where part of it is reflected at the beam splitter interface 3a towards the specimen 5 (though a finger nail is shown in this figure for the specimen 5, it could be a subject's eye, or a subject's ear lope, or subject's tongue for example). The remainder of the light at the interface 3a passes straight through the beam splitter 3, through a half-a-quarter wave phase retarder (pi/4) 6, and finally lands on the mirror 7. Reflected light 8 from the mirror 7, by the time that reaches again the beam splitter interface 3a has gone through quarter wave (pi/2) phase retardation. In FIG. 1, reflected light 8 from the mirror 7 is considered to be the reference light. The amplitude of the reference light 8 must be appropriately reduced to match that portion of the reflected light 4 from the specimen 5 which carries the phase information. This could be achieved by depositing a light absorbing layer, of required thickness and density, over the mirror 7. The reference light 8 is reflected at the beam splitter interface 3a and is combined with the reflected light 4 from the specimen 5. These two lights are directed towards a second polarizer (analyzer) 13 whose axis is perpendicular to the first polarizer 2. The analyzer 13 thus removes any original incident light upon specimen 5, and allows the reference light 8 and the reflected light 4 from the specimen 5, which carries its phase information, to pass through. The emergent light 9 from the analyzer 13 is phase information carrier light from the specimen 5 modulated appropriately by the reference light 8. The emergent light 9 is finally recorded digitally on a CCD for example or investigated visually through a lens system.

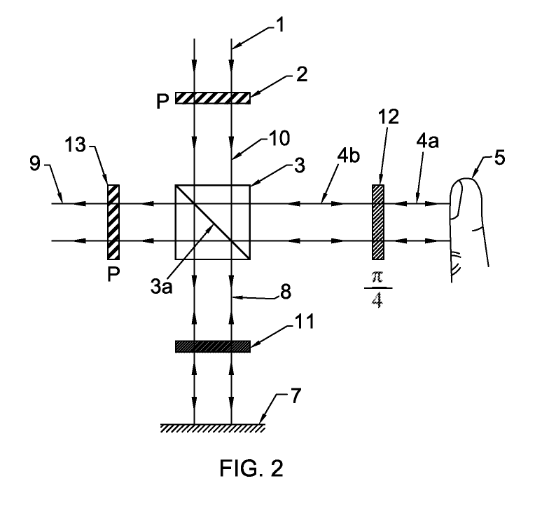

FIG. 2 shows an alternative configuration for PCI. Collimated beam 1 first passes through a polarizer 2 whose axis is set at 45 degrees. The emergent light 10 from the polarizer 2 then impinges on a beam splitter 3, and part of it is reflected at the beam splitter interface 3a and passes through half-a-quarter wave phase retarder (pi/4) 12 to reach the specimen 5. The remainder of the light at the interface 3a passes straight through the beam splitter 3, through a light attenuator 11, and finally lands on the mirror 7. The amplitude of the reflected light 8 from mirror 7, the reference light, thus is adequately reduced through the round trip through the attenuator 11 in order to match the amplitude of that portion of the reflected light from the specimen 5 which carries phase information. Note that in this scheme, the light 4b emergent from the specimen and reaching back to the beam splitter's interface 3a not only carries a fixed quarter wave phase retardation (due to the phase retarder 12), but more importantly the phase of diffracted light by the specimen carries information about structure of the specimen. This phase information has been imposed on the incident polarized light upon specimen 5 due to birefringence and minute and optical path differences of the fine underlying tissues of the specimen. The reference light 8, and the light from the specimen 4b, are thus combined at the beam splitter interface 3a and directed towards another polarizer 13 whose axis is in parallel to the first polarizer 2. Light coming out of the second polarizer 13 thus are composed of two components of almost equivalent amplitudes: One is the reference light, and the other is the light from the specimen with its phase information. The reference light thus modulates the light from the specimen according to its phase content to produce a phase contrast image of the specimen that could be recorded on a CCD, a CMOS imager, or visualized through a lens system.

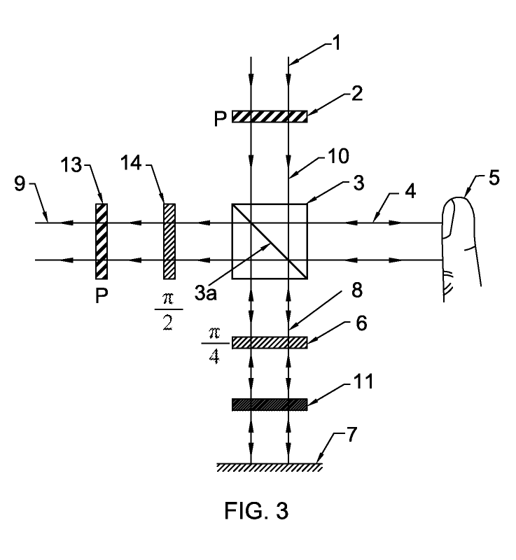

FIG. 3 shows yet another alternative configuration for PCI. Collimated beam 1 first passes through a polarizer 2 whose axis is set at 45 degrees. The emergent light 10 from the polarizer then impinges on a beam splitter 3 where part of it is reflected at the beam splitter interface 3a towards the specimen 5. The remainder of the light at the interface 3a passes straight through the beam splitter 3, through a half-a-quarter wave (pi/4) retarder 6, through a light attenuator 11, and finally lands on the mirror 7. The amplitude of the reflected light 8 from mirror 7, the reference light, is adequately reduced through the round trip through attenuator 11 to match the light's amplitude 4 produced by scattering/diffraction from the specimen. Note once again that the light emergent from the specimen carries information about fine structure of the specimen through its phase. The reference light 8, and the light from the specimen 4, are thus combined at the beam splitter interface 3a and directed towards a quarter-wave retarder 14. The light passing through the quarter-wave retarder 14 then reaches the second polarizer 13 whose axis is in parallel to the first polarizer 2. Note that quarter-wave retarder 14 has a dual function: It introduces a pi/2 phase into the light coming back from the specimen. Should this light contain any component of incident polarized light 10, it will be removed once it reaches the second polarizer 13 whose axis is parallel with the first polarizer 2. The other purpose of the quarter-wave retarder 14 is to introduce an additional phase retardation of pi/2 for the reference light 8′s phase which has already suffered a quarter wave retardation by a round trip through the half-a-quarter wave retarder 6. Therefore, the quarter-wave retarder 14 introduces a quarter wave phase difference into the diffracted light from the specimen with respect to the reference light 8. The emergent light 9 from the polarizer 13 is a diffraction light which is produced by modulating the light emergent from the specimen by the reference light. The light exiting from the polarizer 13 thus carries enhanced structural details of the specimen which could be recorded digitally on a CMOS imager, CCD, or viewed through a lens system.

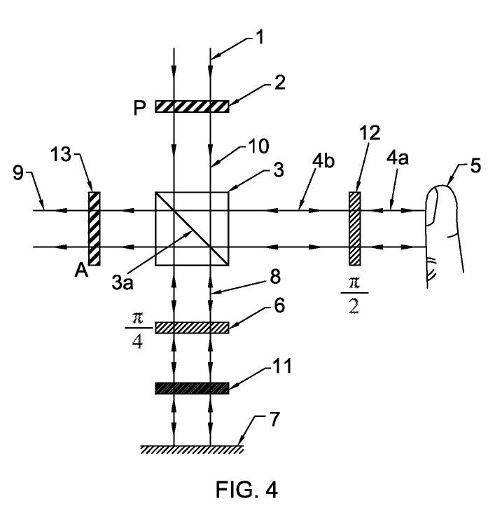

FIG. 4 shows another alternative configuration for PCI. Collimated beam 1 first passes through a polarizer 2 whose axis is set at 45 degrees. The emergent light 10 from the polarizer then impinges on a beam splitter 3, and part of it is reflected at the beam splitter interface 3a and passes through quarter wave phase retarder 12 towards the specimen 5. The remainder of the light at the interface 3a passes straight through the beam splitter 3, through a half-a-quarter wave (pi/4) retarder 6, through a light attenuator 11, and finally lands on the mirror 7. The amplitude of the reflected light 8 from the mirror 7, the reference light, is adequately reduced through the round trip through attenuator 11 to match the light's amplitude 4b produced by scattering/diffraction from the specimen. Note once again that the light emergent from the specimen carries information about fine structure of the specimen through its phase. The reference light 8, and the light 4b from the quarter wave retarder 12, are thus combined at the beam splitter interface 3a and directed towards the polarizer 13 (the analyzer) whose axis is in perpendicular to the polarizer 2. Note that quarter-wave retarder 12 introduces a pi/2 phase into the light coming back from the specimen (or a half-wave “pi” retardation into the incident light 4a which is then reflected 4b from specimen 5). Should this light 4b contains any component of incident polarized light 10, it will be removed once it reaches the analyzer 13. The reference light 8′s phase also experiences a quarter wave retardation by a round trip through the half-a-quarter wave retarder 6. Therefore, the quarter-wave retarder 12, and half-a-quarter wave (pi/4) retarder 6 introduce a quarter wave phase difference into the diffracted light from the specimen with respect to the reference light 8. The emergent light 9 from the analyzer 13 is a diffraction light which is produced by modulating the light emergent from the specimen by the reference light. The light exiting from the analyzer 13 thus carries enhanced structural details of the specimen which could be recorded digitally on a CMOS imager, CCD, or viewed through a lens system.

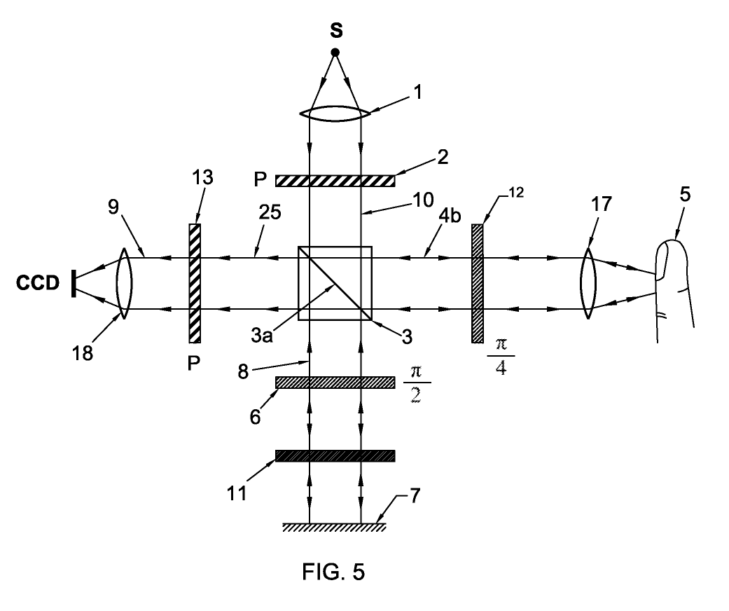

FIG. 5 shows a similar situation to what was described above for FIG. 4 albeit more comprehensive. Light emergent from the light source S is first collimated by the lens system 1, and then passes through a linear polarizer 2, whose axis set at 45 degrees, before reaching the beam splitter interface 3a. At the beam splitter interface 3a, part of the emergent light 10 from the polarizer 2 is reflected towards the specimen 5, and the remaining part passes through the beam splitter 3 and makes a round trip through the quarter wave (pi/2) phase retarder 6 while being reflected by the mirror 7. The light 8 coming back from the mirror 7 is the reference light. The reference light 8 is then reflected by the beam splitter interface 3a towards a second polarizer 13 whose axis is in parallel to the first polarizer 2. The other part of the light 10 which is reflected by the beam splitter interface 3a towards the specimen 5, makes a round trip to and back from the specimen 5 through a half-a-quarter wave (pi/4) phase retarder 12. The light reflected back from the specimen 4b experiences some phase retardation due to the specimen underlying structure, as well as quarter wave (pi/2) retardation due to round trip through the half-a-quarter-wave phase retarder 12. The reflected light from the specimen 4b passes through the beam splitter 13 before reaching the second polarizer 13. The polarizer 13 removes any residue of the incident light 10 from the specimen, while allowing the reference light 8 and the light diffracted by the specimen to pass through. The emergent light 9 from the analyzer 13 is a diffraction light which is produced by modulating the light emergent from the specimen by the reference light. The light exiting from the analyzer 13 thus carries enhanced structural details of the specimen which could be recorded digitally on a CMOS imager, CCD, or viewed through a lens system.

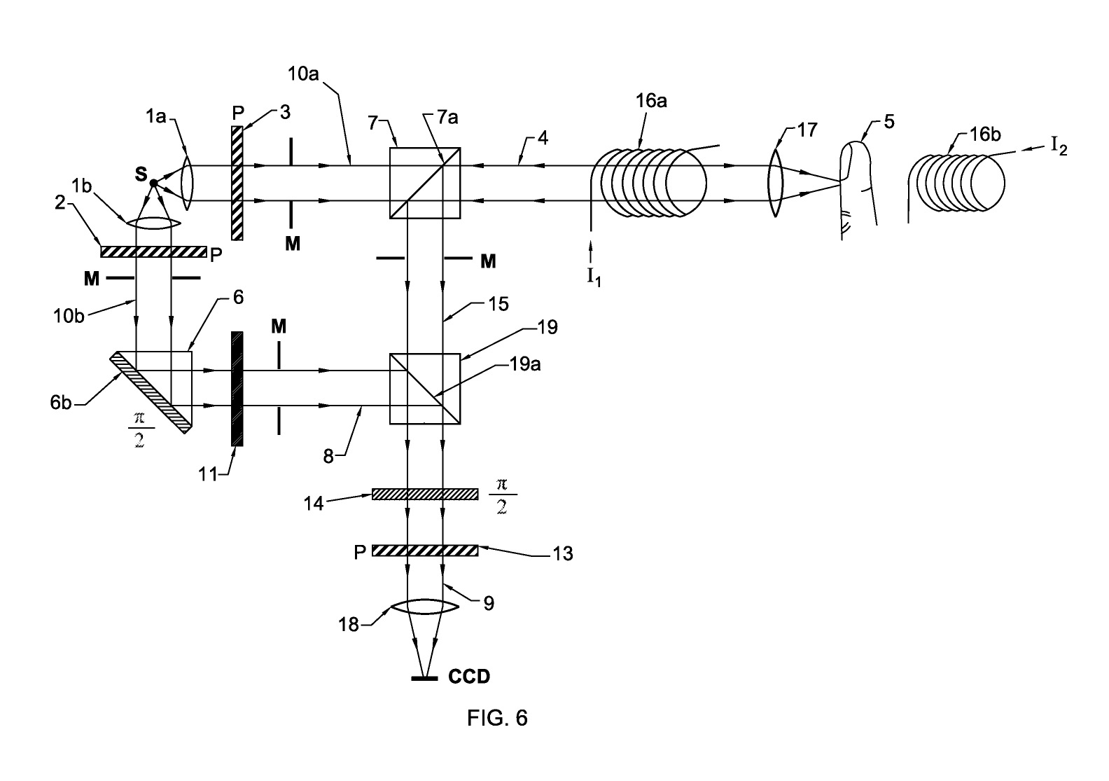

FIG. 6 shows a more comprehensive approach to PCI which is once again based on the same concept. In this figure, however, lens systems 1a, 1b, 17, and 18 are introduced for generation and focusing of collimated light. Also, magnetic coils 16a and 16b are shown in a Helmholtz Coil configuration for dealing with paramagnetic cells. The half quarter retarder 6 is similar to the one proposed by P. Lotis (J. Phys. Rad. 18, 51S[113]. 1957). Also, a number of masks designated by “M” are introduced as to reduce stray light into the system. Light emergent from the light source S are divided to two separate and collimated beams via lens systems 1a and 1b before reaching two identical polarizers 2 and 3 whose axes are both set to 45 degrees. One collimated light 10b goes through a quarter wave retarder 6 and then attenuated appropriately by the attenuator 11 before reaching the beam splitter's interface 19a. The emergent light 8 from the attenuator 11 is the reference light. Note that a number of light masks, designated by M, are placed at some critical pathways of the light in order to remove stray light reaching the final image plane.

The other collimated light 10a passes through the beam splitter 7, passes possibly through the magnetic coil 16a, and then is focused or projected on the specimen 5 through the objective lens system 17. The gradient of the magnetic field will cause free paramagnetic (for example, Hemozoin in the microcirculatory vessels) cells to be concentrated in the optical field of view of the biological entity under investigation. The reflected light from the biological sample is a combination of back scattered background light and those diffracted by the biologic cells under study. The reflected light from the biological entity passes through the objective lens 17 which collimates the light back towards the beam splitter 7 once again through the magnetic field. The emergent light 4 from the magnetic field is reflected at the beam splitter interface 7a towards the beam splitter 19. Light 15 emergent from the beam splitter interface 7a is then combined with the reference light 8 and together they pass through the quarter wave phase retarder 14 and reach the polarizer 13. The polarizer 13 has its axis in parallel to the first and second polarizers 2 and 3. The light 9 emergent from the polarizer 13 is finally focused by the lens system 18 onto a CCD or CMOS imager, or viewed by the user of the invention.

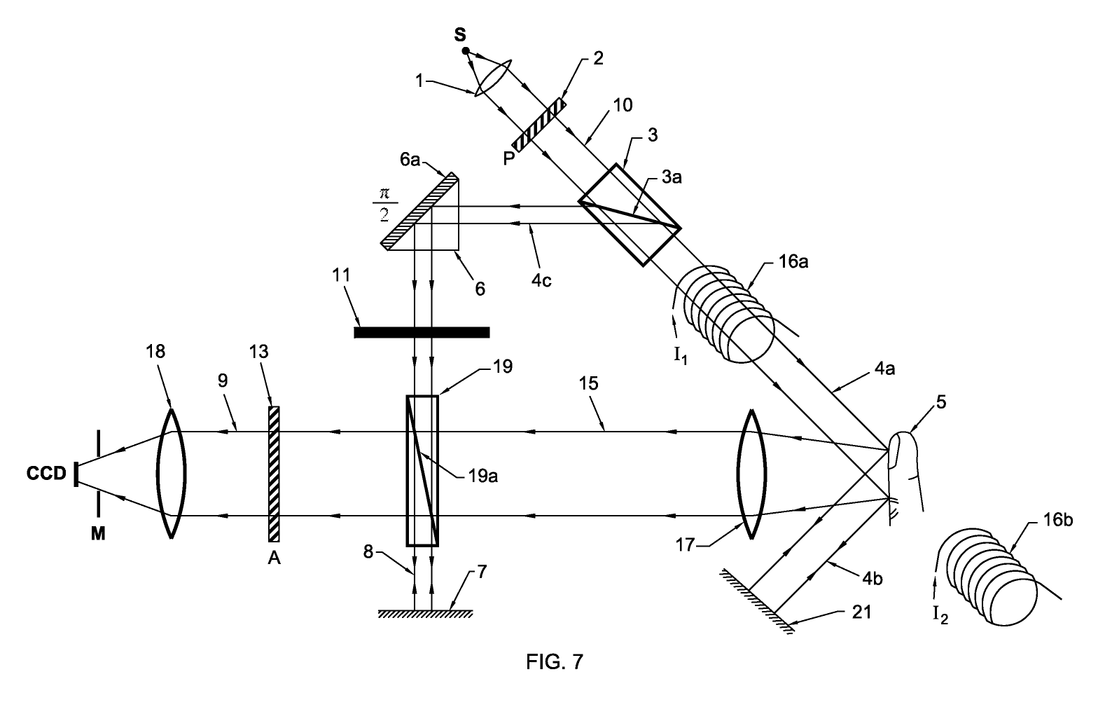

FIG. 7 shows another alternative to PCI implementation. In this scheme, light source S is collimated by the lens system 1 and then passes through the polarizer 2 whose axis is set at 45 degrees. The light 10 emergent from the polarizer 2 passes through beam splitter 3, possibly passes through the magnetic coil gradient generator 16a, and then lands on the specimen 5. The light at the specimen scatters towards the lens system 17 as well as being reflected towards the mirror 21. The mirror 21 reflects the light 4b back towards the specimen which is then reflected back through the magnetic coil 16a before being reflected at the beam splitter interface 3a. The angle of interface 3a is set at a glazing value in order not to introduce any undesired polarization into the reflected light 4c at the beam splitter interface 3a. The emergent light from the beam splitter 3a impinges on the quarter-wave phase retarder 6, attenuated by the light attenuator 11, passes through beam splitter 19, reflected by mirror 7, before being reflected by the beam splitter interface 19a toward the second polarizer (the analyzer) 13. This is our reference light 8. The quarter-wave phase retarder 6 could be similar to the structure proposed by P. Lotis (J. Phys. Rad. 18, 51S[113]. 1957). In fact, since reflection of the light at the interface 19a will introduce additional polarization, the deposited layer's thickness 6a should be controlled as such that the combination of phase retarder 6, and the reflection at the beam splitter interface 19a together will introduce a quarter-wave phase retardation in the reflected light 4c from the beam splitter 3. The second polarizer (the analyzer) 13 axis is in perpendicular to first polarizer 2.

The light scattered from the specimen 5 and collimated by the lens 17 passes through the beam splitter 19 and then impinges on the analyzer 13. The emergent light 9 from the analyzer 13 is a diffraction light which is produced by modulating the light emergent from the specimen by the reference light. The light exiting from the analyzer 13 thus carries enhanced structural details of the specimen which could be recorded digitally on a CMOS imager, CCD, or viewed through a lens system 18.

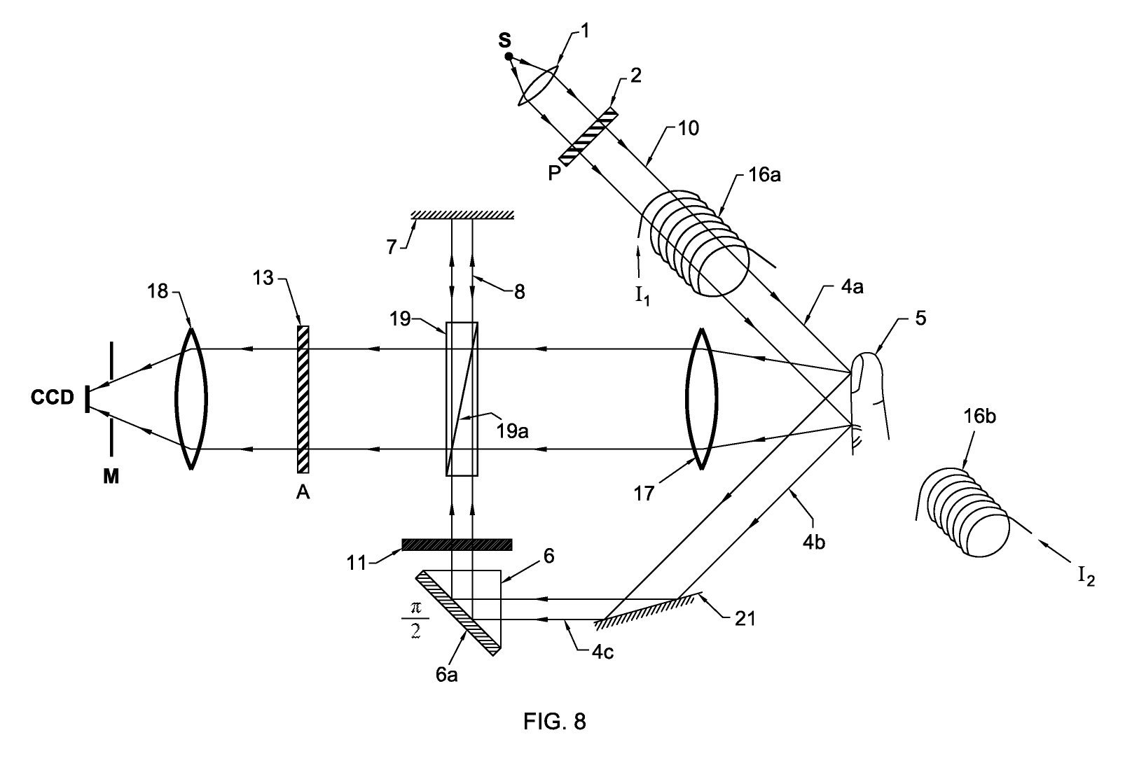

FIG. 8 shows a similar and alternative to what is described above for FIG. 7. The difference here being that the light reflected from the specimen 5 is not reflected back towards the specimen 5 by the mirror 21. Instead, the light is reflected by the mirror 21 towards a quarter-wave phase retarder 6 which in turn sends the light though the light attenuator 11, through the beam splitter 19 and towards the mirror 7. The reflected light 8 from the mirror 7 is the reference light which would be directed by the beam splitter interface 19a towards the analyzer 13. Note once again that the mirror 21 is set at a glazing angle and thus only introduces a half-wave phase retardation on the incident light 4b.

In either FIG. 7, or FIG. 8, it is understood that the collimated light 10 emergent from polarizer 2 may travel through the lens system 17 to reach the specimen 5.

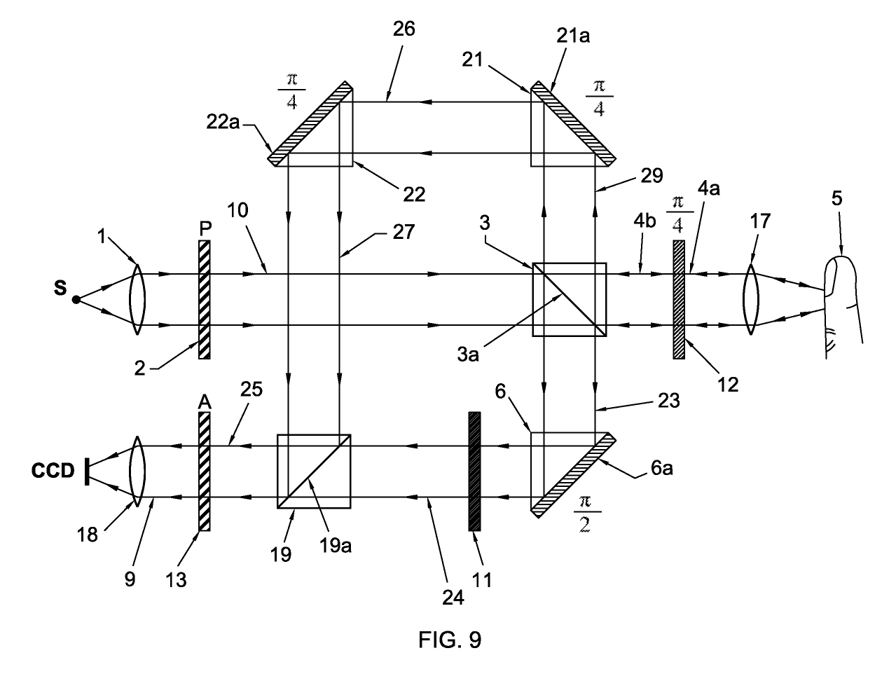

FIG. 9 shows another alternative scheme for PCI. In this scheme, light emergent from the light source S is first collimated by the lens system 1 and then passes through the polarizer 2 whose axis is set at 45 degrees. Part of the emergent light 10 from the polarizer 2 is reflected at the beam splitter interface 3a towards the quarter-wave phase retarder 6, and the other part of the light 10 goes through the beam splitter 3 to reach the specimen 5 through another half-a-quarter-wave retarder 12 and lens system 17. The phase retarder 6 is once again of the type suggested by P. Lotis where the thickness of deposit layer 6a is chosen appropriately such that reflection at the beam splitter interface 3a, and that at 6a would add up to a quarter-wave phase retardation. Light emergent from the phase retarder 6 is then attenuated by the light attenuator 11 to form our reference light 24. The reflected and diffracted light from the specimen 5 travels back through the lens system 17, and then through the half-a-quarter wave phase retarder 12 to reach back the beam splitter 3. The light coming from the specimen 4b is reflected at the beam splitter interface 3a towards the half-a-quarter wave phase retarder 21. The emergent light 26 from the half-a-quarter wave phase retarder 21 is reflected by the half-a-quarter wave phase retarder 22 towards the beam splitter 19. Both half-a-quarter wave phase retarders 21 and 22 are of the type suggested by P. Lotis, where the deposited layers 21a and 22a have appropriate thickness such that phase retardation due to reflection at the interfaces 3a and 19a would yield a total phase retardation of a a quarter wave (pi/2). The light 27 emergent from the half-a-quarter wave phase retarder 22 is reflected at the beam splitter interface 19a towards a second polarizer (analyzer) 13 whose axis is in perpendicular to the first polarizer 2. The two lights, namely light 24 from the attenuator 11 and the light 27 reflected at the beam splitter interface 19a are combined and together they travel towards the analyzer 13. The light 9 exiting from the analyzer 13 thus carries enhanced structural details of the specimen which could be recorded digitally on a CMOS imager, CCD, or viewed through a lens system 18.

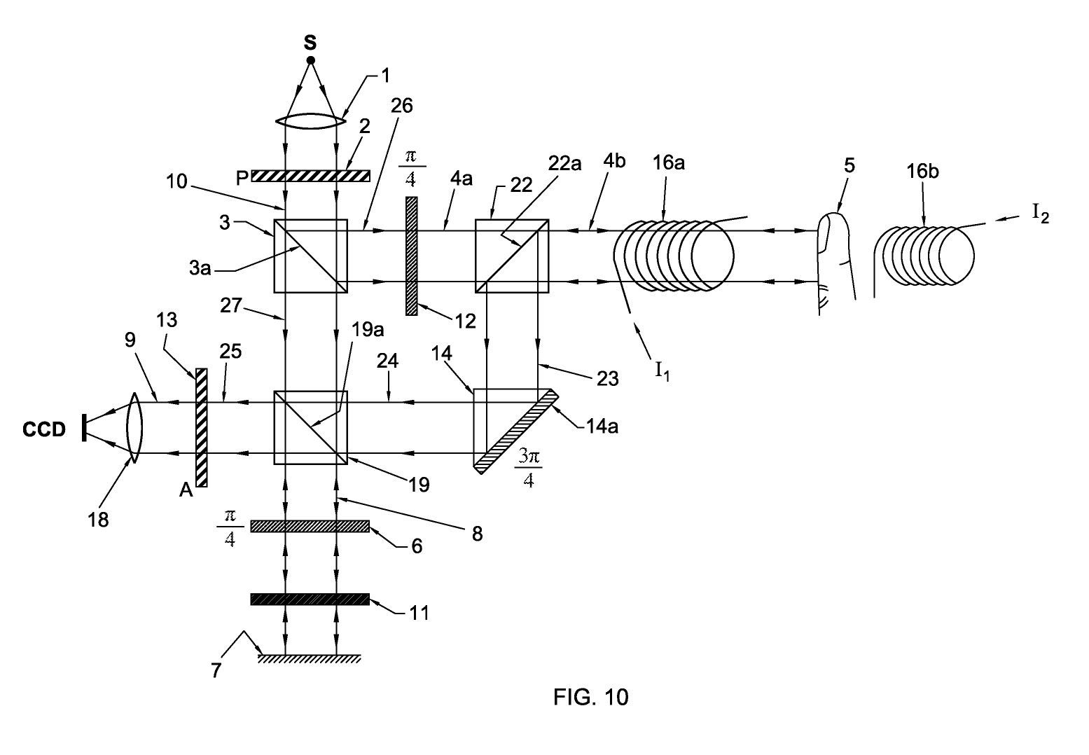

FIG. 10 is yet another depiction of the PCI. In this diagram, the light emergent from the light source S is first collimated by the lens system 1 and then passes through the polarizer 2 whose axis is set at 45 degrees. The light 10 emergent from the polarizer 2 is partially reflected 26 at the beam splitter 3a towards the specimen 5, and the other part passes through beam splitter 3 to form the light labeled as 27. This light 27 furthermore passes through the beam splitter 19, goes through a half-a-quarter wave phase retarder 6 and a light attenuator 11 before landing on the mirror 7. The light 8 reflected back from the mirror 7 through the attenuator 11 and half-a-quarter wave retarder 6 is the reference light. On the other hand, the light 26 reflected from the beam splitter interface 3a passes through a half-a-quarter wave retarder 12, passes through beam splitter 22, passes through potentially a magnetic gradient generator 16a to reach the specimen 5. The light 4b reflected from the specimen 5 is reflected at the beam splitter interface 22a, and then once again by the one-and-a-half quarter wave retarder 14 (3*pi/4) towards the beam splitter 19. Note once again that the one-and-a-half quarter wave retarder 14 is of the type suggested by P. Lotis where an appropriate thickness of the deposited layer 14a is chosen such that a total phase retardation of a one-and-a-half quarter-wave (3*pi/4) is dictated onto the reflected light 4b from the specimen 5 by both reflection at the beam splitter 22a, and the phase retarder 14. The light 25 emergent from the beam splitter 19 is a combination of the light 24 from the specimen 5, and the reference light 8 reflected at the beam splitter interface 19a. This light 25 is directed towards the the second polarizer (the analyzer) whose axis is set perpendicular to that of the first polarizer 2. The light 9 exiting from the analyzer 13 thus carries enhanced structural details of the specimen which could be recorded digitally on a CMOS imager, CCD, or viewed through a lens system 18.

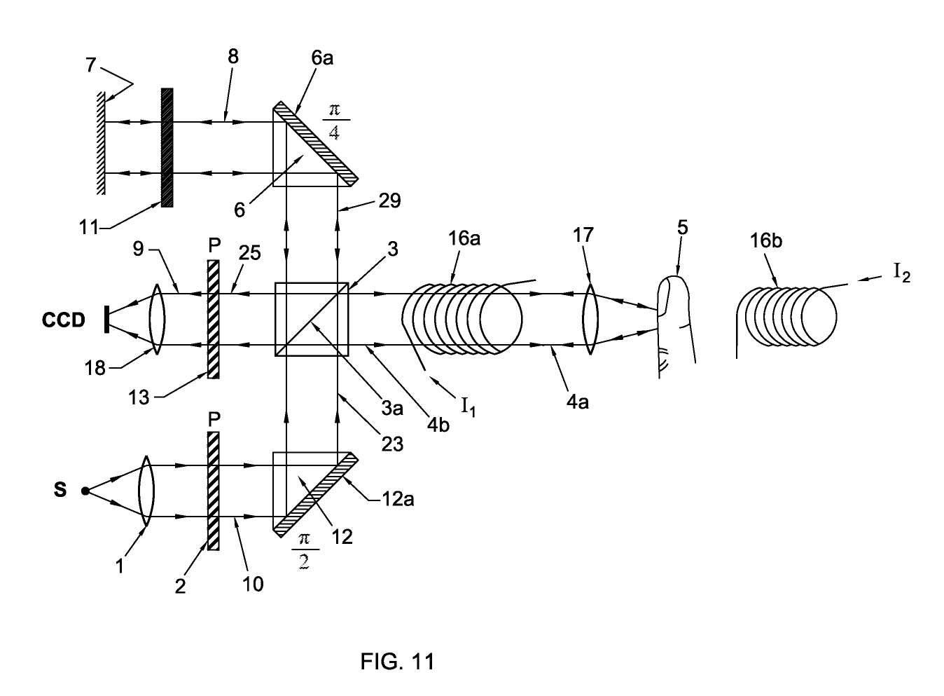

FIG. 11 shows another embodiment of the PCI. In this diagram, the light emergent from the light source S is first collimated by the lens system 1 and then passes through the polarizer 2 whose axis is set at 45 degrees. The light 10 emergent from the polarizer 2 is reflected 23 by the quarter-wave phase retarder 12 (pi/2) towards the beam splitter 3. Part of this light 23 is reflected 4a towards the specimen 5 at the beam splitter interface 3a, and the other part passes through the beam splitter 3 and reaches a half-a-quarter wave phase retarder 6. The reflected light 8 from the half-a-quarter wave phase retarder 6 passes through a light attenuator 11 before being reflected back 8 towards the half-a-quarter wave phase retarder 6 by the mirror 7. The light reflected back 29 by half-a-quarter wave phase retarder 6 towards the beam splitter 3 is the reference light. On the other hands, the light 4a reflected by the beam splitter interface 3a potentially passes through a magnetic gradient generator 16a and lens system 17 to reach the specimen 5. The scattered and diffracted light 4b from the specimen 5 travels back through the lens system 17 and magnetic gradient generator 16a to reach the beam splitter 3. The light 25 emergent from the beam splitter interface 3a is a combination of the light 4b from the specimen 5, and the reference light 29. This light 25 is directed towards the the second polarizer 13 whose axis is set in parallel to that of the first polarizer 2. The light 9 exiting from the polarizer 13 thus carries enhanced structural details of the specimen which could be recorded digitally on a CMOS imager, CCD, or viewed through a lens system 18.

It should be noted that the two phase retarders 12 and 6 in FIG. 11 are of the type suggested by P. Lotis, where the thickness of the deposited layers 12a and 6a are chosen appropriately. The thickness 12a is such that there would be a total of a quarter-wave retardation for the light 10 that is first reflected by the phase retarder 12, and then reflected 4a again towards the specimen 5 at the beam splitter interface 3a. Similarly the thickness 6a is such that there would be a total of a quarter-waver retardation for the round trip travel of light 29 to and from the mirror 7, as well as the reflection 25 towards the analyzer 13 at the beam splitter 3a.

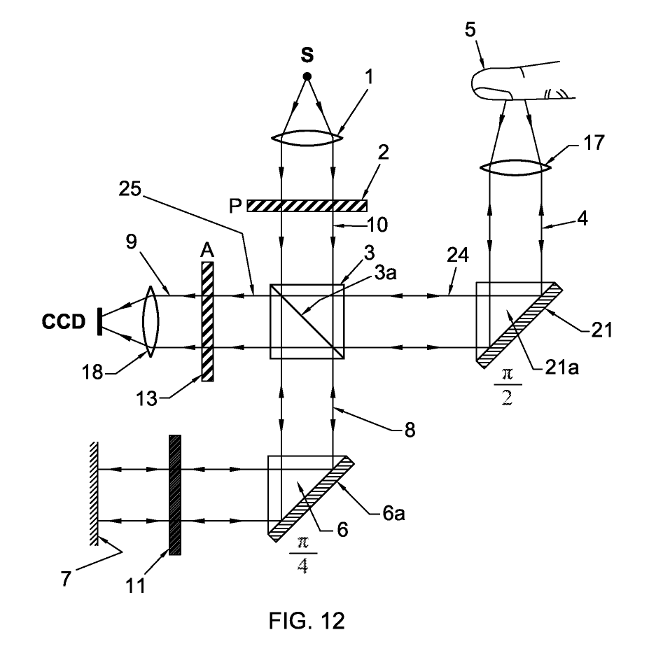

FIG. 12 is another depiction of the PCI and similar to what was described for FIG. 11. The light emergent from the source S is first collimated by the lens system 1 and then passes through a polarizer 2 whose axis is set at 45 degrees. Part of the emergent light 10 from the polarizer 2 passes through the beam splitter 3 and travels a round trip to and from the mirror 7 through the half-a-quarter wave phase retarder 6 (pi/4), and the light attenuator 11. The reflected light 8 from the mirror 7 which reaches back the beam splitter 3 is the reference light. The other part of the emergent light 10 from the polarizer 2 is reflected by the beam splitter 3a towards the specimen 5. This light travels a round trip to and from the specimen 5 through a quarter-wave phase retarder 21, possibly through a magnetic gradient generator (not shown), and through a lens system 17. The reflected light 24 from the specimen 5 is combined with the reference light 8 at the beam splitter 3a and together they are directed towards a second polarizer (analyzer) 13 whose axis is set perpendicular to that of the first polarizer 2. The light 9 exiting from the analyzer 13 thus carries enhanced structural details of the specimen which could be recorded digitally on a CMOS imager, CCD, or viewed through a lens system 18.

As mentioned for FIG. 11, the phase retarders 6 and 21 are similar to the structure proposed by P. Lotis and have appropriate thickness for the deposited layers 6a, and 21a to account for phase retardation by reflection at the beam splitter interface 3a.

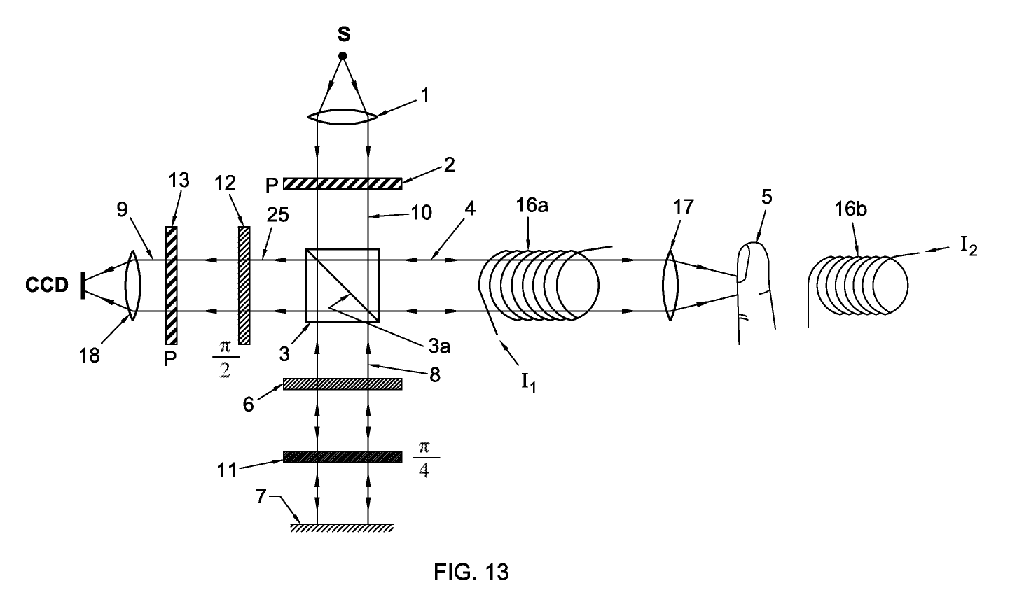

FIG. 13 shows another implementation of PCI. The light emergent from the source S is first collimated by the lens system 1 and then passes through a polarizer 2 whose axis is set at 45 degrees. Part of the emergent light 10 from the polarizer 2 passes through the beam splitter 3 and travels a round trip to and from the mirror 7 through the half-a-quarter wave phase retarder (pi/4) 6, and the light attenuator 11. The reflected light 8 from the mirror 7 which reaches back the beam splitter 3 is the reference light. The other part of the emergent light 10 from the polarizer 2 is reflected by the beam splitter 3a towards the specimen 5. This light travels a round trip to and from the specimen 5 through a magnetic gradient generator 16a, and through a lens system 17. The reflected light 4 from the specimen 5 is combined with the reference light 8 at the beam splitter interface 3a and together 25 they are directed towards another quarter-wave phase retarder (pi/2) 12. The emergent light from the quarter-wave phase retarder 12 is incident on a second polarizer 13 whose axis is set in parallel to that of the first polarizer 2. The light 9 exiting from the analyzer 13 thus carries enhanced structural details of the specimen which could be recorded digitally on a CMOS imager, CCD, or viewed through a lens system 18.

Similar to the situation shown in FIG. 12, the phase retarders 6 could use a structure similar to the one proposed by P. Lotis and has appropriate thickness for the deposited layer 6a to account for phase retardation by reflection at the beam splitter interface 3a. The deposited layer thickness 6a is chosen such that there would be a total phase retardation of pi/2 (quarter-wave phase retardation) for a round trip travel through the phase retarder 6, and the reflection of the reference light 8 by the beam splitter interface 3a.

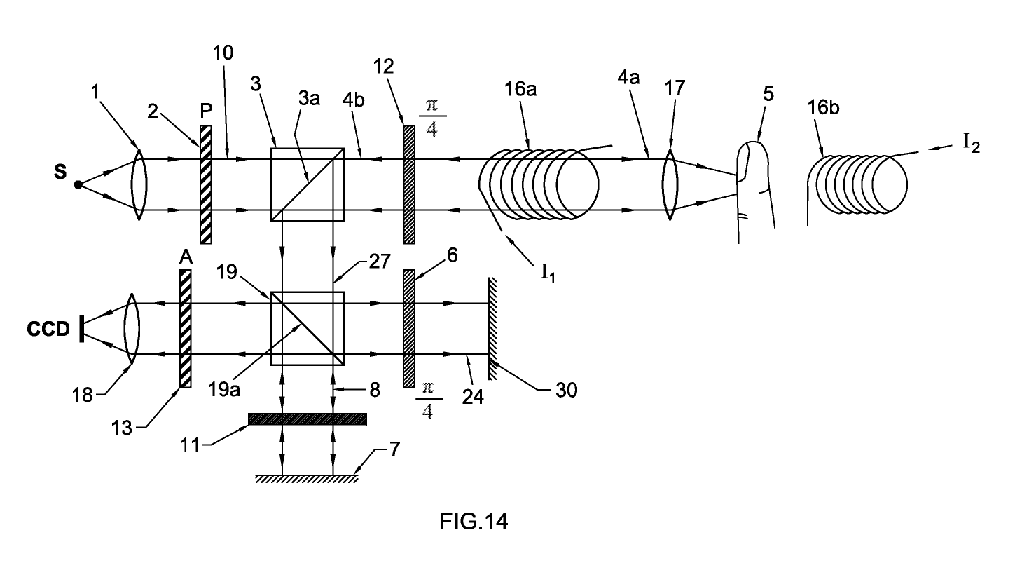

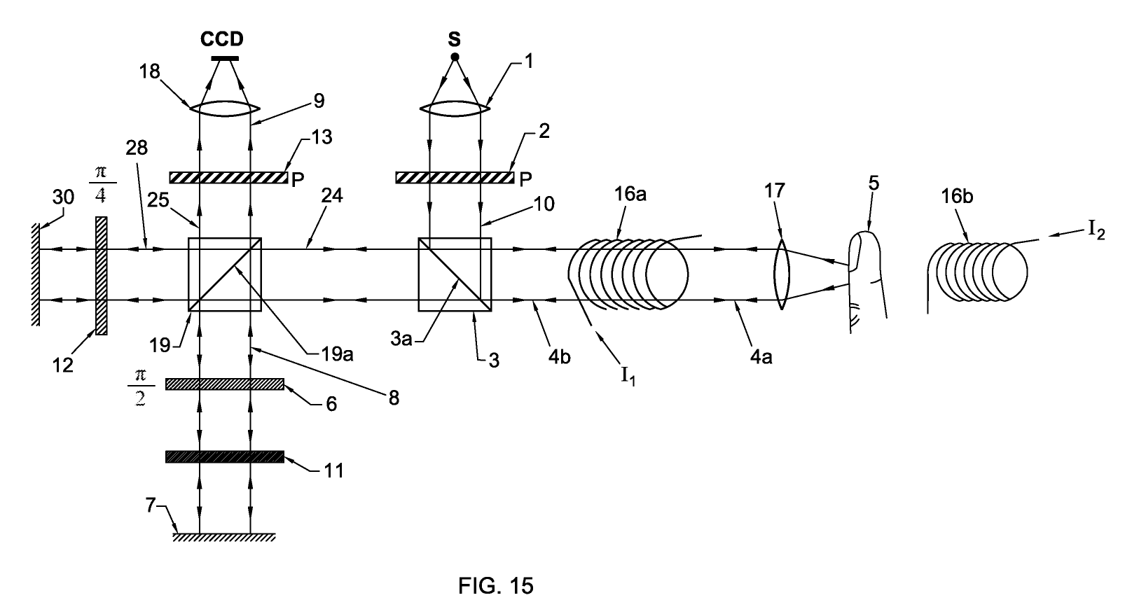

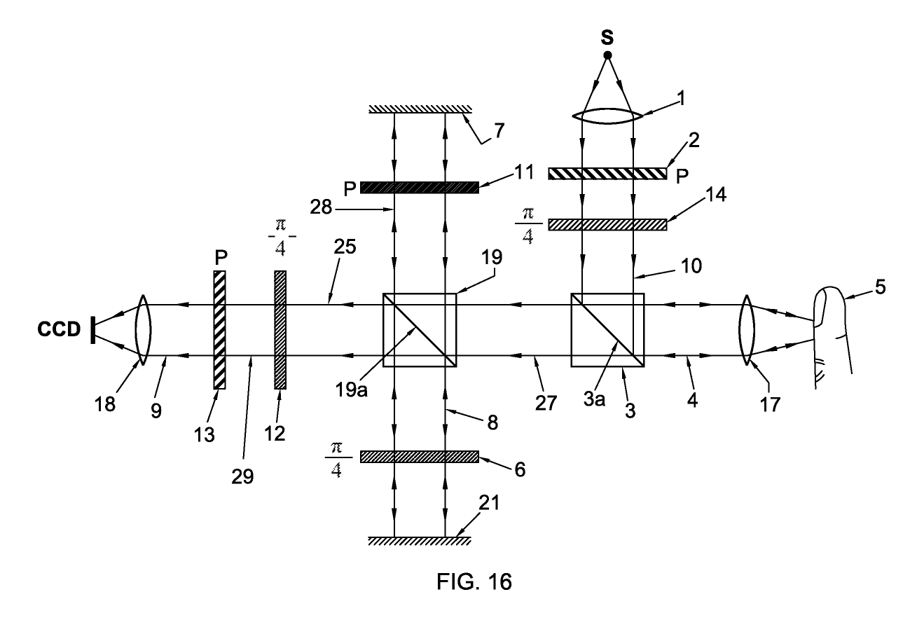

FIG. 14 shows another alternative scheme for PCI. It must be noted that what is different in this figure (as well as in FIGS. 15, and 16)compared to other figures shown in this invention is the important fact that the reference light is generated off of the reflected light from the specimen instead of directly from the light source. In this scheme, light emergent from the light source S is first collimated by the lens system 1 and then passes through the polarizer 2 whose axis is set at 45 degrees. Part of the emergent light 10 from the polarizer 2 goes through the beam splitter 3, passes through the half-a-quarter wave retarder 12, and possibly through magnetic gradient generator 16a, and lens system 17 to reach the specimen 5. The reflected and diffracted light from the specimen 5 travels back through the lens system 17, through the magnetic gradient generator 16a and then through the half-a-quarter wave phase retarder 12 to reach back the beam splitter 3. The light 4b reaching the beam splitter 3 will be reflected 27 by the beam splitter interface 3a towards the second beam splitter 19. Part of this light 27 passes through the beam splitter 19, and makes a round trip through the light attenuator 11 as is reflected back by the mirror 7. The reflected light from the mirror 7 is the reference light 8. The other part of the light 27 is reflected at the beam splitter interface 19a and makes a round trip through half-a-quarter wave phase retarder 6 while being reflected back by the mirror 30. The reflected light 24 from the mirror 30, and the reference light 8 are combined at the beam splitter interface 19a and together travel towards a second polarizer (analyzer) 13 whose axis is perpendicular to the first polarizer's axis 2. The light 9 exiting from the analyzer 13 thus carries enhanced structural details of the specimen which could be recorded digitally on a CMOS imager, CCD, or viewed through a lens system 18.

FIG. 15 shows another alternative scheme for PCI where the reference light, as in FIG. 14, is created off of the reflected light from the specimen. In this scheme, light emergent from the light source S is first collimated by the lens system 1 and then passes through the polarizer 2 whose axis is set at 45 degrees. The emergent light 10 from the polarizer 2 is reflected by the the beam splitter interface 3a towards magnetic gradient generator 16a, and through lens system 17 to reach the specimen 5. The reflected and diffracted light from the specimen 5 travels back through the lens system 17, and then through the magnetic gradient generator 16a to reach back the beam splitter 3. The light 4b reaching the beam splitter 3 will pass through it to reach a second beam splitter 19. Part of this light 24 passes through the beam splitter 19 and makes a round trip through half-a-quarter (pi/4) phase retarder 12 while being reflected by the mirror 30. The reflected light 28 from the mirror 30 which has undergone a total phase retardation of a quarter-wave (pi/2) via the phase retarder 12 is then reflected by the beam splitter interface 19a towards a second polarizer 13 whose axis is in parallel to the first polarizer's axis 2. The other part of the light 24 is reflected by the beam splitter 19a, and makes a round trip through a quarter-wave phase retarder 6, and the light attenuator 11 while being reflected by the mirror 7. The reference light 8 coming back from the mirror 7 passes through the beam splitter 19 towards the polarizer 13 and is combined with the light 28 coming from the mirror 30. The light 9 exiting from the polarizer 13 thus carries enhanced structural details of the specimen which could be recorded digitally on a CMOS imager, CCD, or viewed through a lens system 18.

FIG. 16 shows another alternative scheme for PCI where the reference light, as in FIG. 14 and FIG. 15, is created off of the reflected light from the specimen. In this scheme, light emergent from the light source S is first collimated by the lens system 1 and then passes through the polarizer 2 whose axis is set at 45 degrees. The emergent light 10 from the polarizer 2 passes through half-a-quarter wave phaser retarder 14 (pi/4) and is reflected by the beam splitter interface 3a towards lens system 17 to reach the specimen 5. The reflected and diffracted light 4 from the specimen 5 travels back through the lens system 17 to reach back the beam splitter 3. The light 4 reaching the beam splitter 3 will pass through it 27 to reach a second beam splitter 19. Part of this light 27 is reflected by the beam splitter interface 19a and makes round trip through the light attenuator 11 as it is reflected by the mirror 7. The reflected light 28 is once again reflected by the beam splitter interface 19a and makes another round trip through a half-a-quarter-wave (pi/4) phase retarder 6 as it is reflected by the mirror 21. The reference light 8 reflected from the mirror 21 thus undergoes a quarter-wave phase (pi/2) change due to the half-a-quarter-wave phase retarder 6. The other part of the light 27 is reflected by the beam splitter interface 19a and is combined with the reference light 8. Together they travel towards another half-a-quarter wave phase retarder 12. The emergent light 29 from the half-a-quarter wave phase retarder (pi/4) then passes through a second polarizer whose axis is in parallel to the first polarizer' s axis 2. The light 9 exiting from the polarizer 13 thus carries enhanced structural details of the specimen which could be recorded digitally on a CMOS imager, CCD, or viewed through a lens system 18.

The invention PCI described so far has been depicted in FIGS. 1 through 16 in which light reflected from the specimen 5 has been modulated by a reference beam of light. However, it is well understood that the PCI concept can be extended to cover the situation in which the transmission of light through the specimen 5 is modulated by a reference light to obtain the specimen's detailed underlying structures.

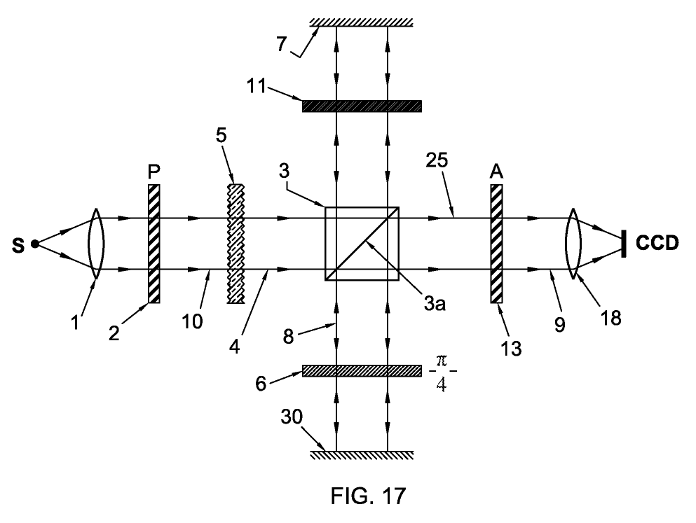

To this effect, FIGS. 17, 18 and 19 are shown examples of PCI in a transmission configuration. Briefly stated, FIG. 17 shows the situation where polarized light 10 emergent from polarizer 2 passes through the specimen 5 under study. The emergent light 4 from specimen is split by the beam splitter 3: part of it makes a round trip between mirrors 7 and 30 as it passes through the light attenuator 11 and half-a-quarter wave phase retarder 6 (pi/4) to form the reference light 8. Although attenuator 11 is shown in FIG. 17 to be between the beam splitter 3 and the mirror 7, it could as well be placed between mirror 30 and the beam splitter 3. The other part of light 4 passes through the beam splitter 3 and is combined with the reference light 8 to reach the second polarizer (analyzer) 13 whose axis is perpendicular to the first polarizer axis 2. The light 9 exiting from the analyzer 13 thus carries enhanced structural details of the specimen which could be recorded digitally on a CMOS imager, CCD, or viewed through a lens system 18.

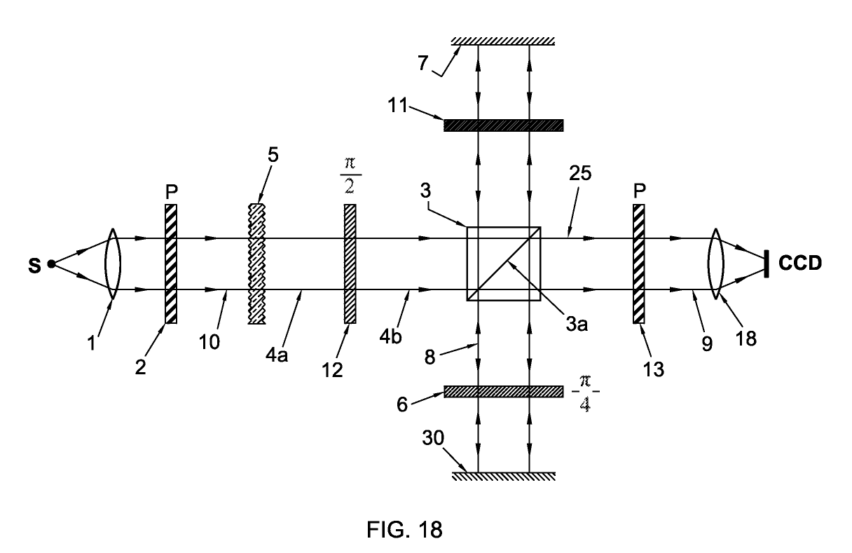

FIG. 18 depicts similar situation as in FIG. 17 except that the emergent light 4a from the specimen 5 first passes through a quarter-wave retarder 12 before impinging on the beam splitter 3. The analyzer 13 in FIG. 17 now is replaced by a polarizer 13 whose axis is in parallel to the first polarizer axis 2.

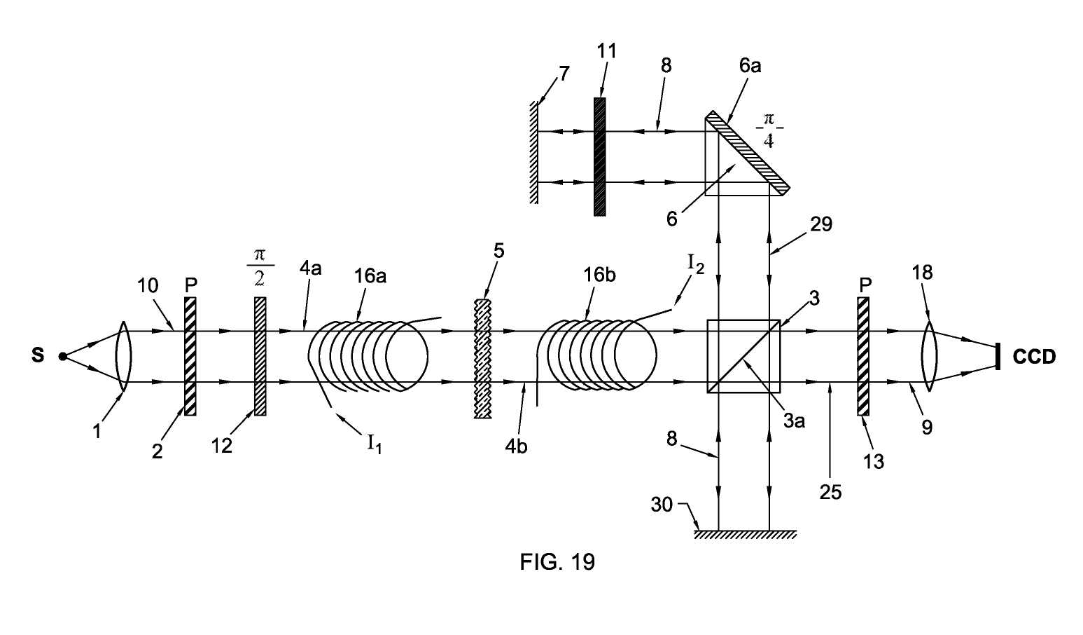

Finally FIG. 19 depicts again the PCI in the transmission mode. Polarized light emergent from the polarizer 2 first passes through a quarter-wave retarder 12, passes potentially through a magnetic field gradient generator 16a and 16b as it travels through the specimen 5. The transmitted light 4b through the specimen 5 is split by the beam splitter 3: part of it makes a round trip between mirrors 7 and 30 as it passes through the light attenuator 11 and half-a-quarter wave retarder 6 to form the reference light 8. Although attenuator 11 is shown in FIG. 19 to be between the beam splitter 3 and the mirror 7, it could as well be placed between mirror 30 and the beam splitter 3. Note also that the retarder 6 could be of the type suggested by P. Lotis where the thickness of the deposited layer 6a is chosen appropriately to have a total phase retardation of pi/2 considering change of polarization due to double reflection of the reference light 8 at the interface 3a. The other part of light 4b passes through the beam splitter 3 and is combined with the reference light 8 to reach a second polarizer 13 whose axis is in parallel to the first polarizer axis 2. The light 9 exiting from the polarizer 13 thus carries enhanced structural details of the specimen which could be recorded digitally on a CMOS imager, CCD, or viewed through a lens system 18.

Note in particular the easy adaptation of FIGS. 1, 3, and 11 to FIGS. 17,18, and 19 respectively. Other figures shown in PCI reflective mode of operation could be modified to accommodate corresponding transmission counter part.

Light source used for the invention should be of high intensities (such as carbon arc, or high powered LEDs). The light source could either have a broad spectrum (such as white LED), or constrained to specific narrow band spectrum. Furthermore, some biological specimen, such as deoxy- and oxyhemoglobin, has absorption bands in the infra-red spectrum. Therefore, use of infra-red light source in PCI would be an alternative consideration in some applications. The source light also could be pulsed in synchronization with the CCD frame rate in order to achieve a synchronized stroboscope appearance.

In order to avoid stray light leaking back into the second polarizer/analyzer in forming the final image, various masks could be used to restrict the light path and direction at critical points of the PCI. The whole PCI needs to be also embedded within a container (optical hosting) whose internal walls are covered with light absorbing material to once again reduce the effects of stray light in the final image.

Surface of lenses used in the invention could be ‘bloomed’ with thin anti-reflection layers in order to reduce the scattering of the light at these boundaries. Furthermore, due to rotation of plane of polarization of the light at these boundaries, one may use “polarization rectifiers” (similar to what originally proposed by Dr. Shinya Inoue') before or after each lens to increase the extinction factor of the system.

The type of polarizers used in this invention could be of the birefringent polarizers such as Nicol prism, Ahrens prism, or Glan-Foucault prism. Instead of a birefringent polarizer, one may use a reflection polarizer (especially in applications where the light source is in the infra-red) such as those developed by F. Abeles (1950, J. de Phys., 11, 403 [99]). The polarizer could also be of dichroic type if a wide spectrum light source is used. It is imperative that one be able to rotate/adjust the axis of one of the two polarizers used in the system with respect to the other one's axis as to optimize the image formation.

It must be noted that instead of a beam splitter a partially silvered mirror could be used. Furthermore, polarization functionality can be combined into the beam splitter if using one of the above polarizer prisms.

The phase retarders used in this invention could be of birefringent retarders such as mica or quartz. They could also be of the reflection retarders such as Fresnel rhomb, or similar types described by Kizel et al(1964, Optics and Spectroscopy 17, 248 [111]), or by Mooney (1952, J. Optical Soc. America 42, 181 [112]). One important point that needs to be considered when dealing with polarized light is that additional phase retardation is imposed on the incident light by the reflection at various surfaces of optical elements. Thus, it is imperative to make sure that the desired phase retardation to be adjusted to accommodate this additional phase retardation. The retarder proposed by M. P. Lostis (1957, J. Phys. Rad. 18, 51S. [113])is an excellent choice as one could select the amount of phase retardation of the incident light by controlling the thickness of the deposited layer.

The magnetic gradient can be produced effectively by a Helmholtz Coil pair as shown in FIG. 12. By changing either the magnitude, or the direction of the two electric currents (I1 and I2) in the coils one can change the intensity and the focal point of magnetic force in the specimen under investigation. By applying a small varying current on a dc-biased current in the coil, one could make free paramagnetic cells to oscillate and thus make them more distinguishable from the background. In some applications it may be also feasible to use a permanent magnet in order to produce a magnetic gradient.

The magnetic coil shown in various figures, can serve another purpose in this invention: It can act as a compensator which is needed in some applications to improve the image contrast of the biological cells. This could be accomplished by filling the coil with a transparent dielectric of proper Verdet constant, and by applying appropriate current in the coil. The polarization plane of the light thus would consequently rotate due to Faraday Effect.

The light attenuator could be a transparent surface upon which some partially light absorbing layer has been deposited to produce a fixed value attenuation. The attenuation may also be controlled electrically by applying appropriate voltage to chemically deposited surfaces whose transparency change according to the applied voltages, or by other means. Yet another possibility is to deposit a light absorbing layer of appropriate thickness and density on the mirror which reflects the light back towards the second polarizer/analyzer (mirror 7 in FIG. 11, 12, or 1 for examples).

Although not shown in figures, it is useful to include a compensator in the reference light path to increase the image contrast projected onto the CCD. Such compensator could simply be a slab of transparent material to compensate for any extra optical paths that the incident light upon specimen needs to travel through.

Finally, the CCD/CMOS imager output could be transferred to a computer for further enhancement of the image by utilizing various digital signal processing techniques. The image captured by the CCD/CMOS imager and transferred to the computer could be thus stored, processed, or displayed on a monitor.

### Example of Usage: Malaria Detection

Malaria diagnostic is one the most neglected area of malaria research according to a study carried out by Malaria R&D Alliance in 2004. Biological diagnosis mostly relies on meticulous preparation of either Leishman blood stain, Giemsa blood stain, or Field's blood stain on a slide and then investigating the slide through a microscope by a skilled and trained microscopist.

As an alternative solution, scientists during the last 50 years have developed another method called Rapid Diagnostic Test (RDT). RDT requires preparation of “an immunochromatographic assay with monoclonal antibodies directed against the target parasite antigen and impregnated on a test strip.” The test strip is then exposed to a small amount of extracted blood. Most commonly used RDTs only detect P. Falciparum malaria parasite, and they are much more expensive compared to blood smear microscopic tests mentioned above.

Detection of malaria in patient constitute a major step in eradication of the disease as accurate identification of malaria parasites in blood would directly influence correct prescription of needed drug and its dosage. Unfortunately, misdiagnosis of malaria has had a major negative impact and contribution to the development of drug resistant malaria parasite.

The above methods are time consuming, inaccurate, requiring blood extraction and preparation as well as needing the test to be carried out by skilled and trained technicians. The invention in this disclosure, PCI, not only tries to overcome the above methods' shortcomings, it provides an investigative tool which could be used to perform the diagnosis in real time and without a need to extract any blood samples.

The principle of detecting malaria by this invention relies on two important properties exhibited by malaria pigment, Hemozoin. The first property is that Hemozoin is birefringent (see for example, Christine Lawrence, “Birefringent Hemozoin Identifies Malaria,” Am. J. Clin. Pathol. 86, 1986, 360-363). The other characteristic of Hemozoin is its paramagnetic property due to the presence of unpaired electrons in the outer orbital that are spinning in the same direction.

Researchers who have tried to utilize the above two properties for diagnosis of malaria had to pump extracted and prepared volume of blood through a pipe which is filled with smooth steel wire. The pipe is then exposed to a magnetic field to separate Hemozoin from the blood flow through the pipe. The magnetic filed is removed after some time and the pipe content is flushed out. The retained Hemozoin is subsequently chemically washed, stained and observed under a polarized microscope which should detect Hemozoin presence in the blood. This method obviously is very time consuming and is not practical in the field.

Instead of relying on the above two properties of malaria, some researchers have discovered that patients with sever cases of Falciparum malaria exhibit blocked microcirculation and capillaries. For their studies, these researchers have used Orthogonal Polarization Spectral Imaging (OPS) devices to perform in vivo assessment of microcirculatory dysfunction in rectal mucosa of adult patients. In OPS imaging, the microcirculation is illuminated with polarized light. The remitted light is projected onto a CCD camera after it passes a second polarizer (analyzer) which is oriented such that its axis is perpendicular to that of first polarizer.

Other researchers have found that in sever malaria cases and children with cerebral malaria, retina provide a diagnostic opportunity due to macular whitening and vessel changes in retina. In these studies, an indirect ophthalmoscope has been used to investigate vascular changes.

Referring to FIG. 11, PCI provides a convenient approach to perform in vivo diagnosis of malaria based upon paramagnetic and birefringent properties of Hemozoin. In FIG. 11, PCI configuration resembles a capillaroscopic instrument studying nail fold capillaries. The Helmholtz coils 16a and 16b will introduce a magnetic gradient, and thus a magnetic force, to attract and increase the concentration of Hemozoin in nail fold microcirculatory vessels in the field of view. Electric currents I1 and 12 flowing into the magnetic coils 16a, and 16b could be adjusted for their magnitudes and directions to focus an appropriate magnetic force field at desired depth of the nail fold. In fact, the electric current flown in the coils could be constant bias currents upon which a small varying current are imposed in order to cause a slight oscillation in the Hemozoin pigments to make them more detectable.

The polarized light impinging on the Hemozoin would experience a minute change of polarization due to birefringent properties of Hemozoin. Such change of polarization is observable at the output of the polarizer 13 where the reference light 29 is used to modulate the intensity of reflected light 4b from the Hemozoin.

The light emerging from the polarizer 13 thus could be recorded digitally on a CCD imager, for example, and transferred to a computer for further digital signal processing in order to enhance the feature of interests. Alternatively, the polarizer output could be visualized through an ocular lens system.

The reference light 29 is used to enhance the phase contrast produced by the Hemozoin. This contrast may be improved further by introducing a compensator in the reference light 29 path.

Usage of lens system 17 is optional provided enough reflection from specimen 5 is achieved by utilizing a high intensity light source S. If lens system 17 is used, then one may also consider a “polarization rectifiers” (similar to what originally proposed by Dr. Shinya Inoue') before or after the lens system 17 to avoid unnecessary additional phase retardation at the lens surface.

What is not shown in FIG. 11 are various masks at critical junctures to avoid stray light reaching the polarizer 13. Also, what is not shown in FIG. 11 is the fact that the whole PCI a unit must be embedded within a seclusion/container with its internal walls covered with light absorbing material to prevent stray light reaching the polarizer 13.

For the light source, monocular light possibly with a wavelength region centered at an isosbestic point (a wavelength at which both forms of hemoglobin absorbs equally) is recommended. Alternatively, one may use near infrared region in order to take advantage of some biological response to infrared light.

What is claimed:

1- A phase polarization imager having four light paths, used to image a specimen comprising:
a beam splitter;
an excitation light path that delivers a beam of polarized light to said beam splitter from a light source;
a specimen light path that delivers part of light from said excitation path to the specimen and returns reflected and diffracted waves from the specimen as specimen light back to said beam splitter;
a reference light path that delivers part of light from said excitation path to a mirror and returns a reference light having a predetermined amplitude and polarization to said beam splitter: and
an analyzer light path that delivers said reference light and said specimen light to a final polarizer/analyzer to from an image.

2- The phase polarization imager according to claim 1, wherein light source of said excitation light path has a narrow bandwidth.

3- The phase polarization imager according to claim 1, Wherein the light source of said excitation light path emits light in infrared range.

4- The phase polarization imager according to claim 1, wherein at least one of four said light paths includes an optical mask.

5- The phase polarization imager according to claim 1 wherein at least one lens system or a lens system equipped with a rectifier is introduced in one of four said light paths.

6- The phase polarization imager according to claim 1, wherein a polarizer of the birefringent polarizer type, reflection type, or dichroic type is used in said excitation light path and/or in said analyzer light path.

7- The phase polarization imager according to claim 1, wherein said beam splitter is a partially silvered mirror.

8- The phase polarization imager according to claim Wherein at least one of four said light paths includes a phase retarder,

9- The phase polarization imager according to claim 1, further comprises a magnetic field gradient generator in said specimen light path.

10- The phase polarization imager according to claim 1, further comprises a light attenuator in said reference light path and is either a transparent surface upon which some partially light absorbing layer has been deposited, or a mirror upon which a light absorbing layer of appropriate thickness and density has been deposited, or a chemically deposited surface whose transparency change according to some applied voltage.

11- The phase polarization imager according to claim 1, further comprises a compensator in said reference light path.

12- The phase polarization imager according to claim 1, further comprises a CCD or CMOS image sensor in said analyzer light path,

13- A phase polarization imager having five light paths, used to image a specimen, comprising:
a beam splitter;
an excitation light path that delivers a beam of polarized light from a light source through a specimen;
a specimen light path which delivers diffracted light emergent from the specimen to said beam splitter;
a reflective light path that delivers part of said specimen light path from said beam splitter towards a mirror and returns a reflected wave back to said beam splitter;
a reference light path that delivers said reflective light through said beam splitter to a mirror and returns a light of predetermined amplitude and polarization to said beam splitter; and
an analyzer light path that delivers said reference light and said specimen light to a final polarizer/analyzer to from an image.

14- The phase polarization imager according to claim 13, wherein light source of said excitation light path has a narrow bandwidth.

15- The phase polarization imager according to claim 13, wherein the light source of said excitation light path emits light in infrared range.

16- The phase polarization imager according to claim 13, wherein at least one of five said light paths includes an optical mask.

17- The phase polarization imager according to claim 13, wherein at least one lens system or a lens system equipped with a rectifier is introduced in one of five said light paths.

18- The phase polarization imager according to claim 13, wherein a polarizer of the birefringent polarizer type, reflection type, or dichroic type is used in said excitation light path and/or in said analyzer light path.

19- The phase polarization imager according to claim 13, wherein said beam splitter is a partially silvered mirror.

20- The phase polarization imager according to claim 13, wherein at least one of five said light paths includes a phase retarder,

21- The phase polarization imager according to claim 13, further comprises a magnetic field gradient generator in said excitation light path and/or said specimen light path.

22- The phase polarization imager according to claim 13, further comprises a light attenuator in said reference light path and/or in said reflective light path and is either a transparent surface upon which some partially light absorbing layer has been deposited, or a mirror upon which a light absorbing layer of appropriate thickness and density has been deposited, or a chemically deposited surface whose transparency change according to some applied voltage.

23- The phase polarization imager according to claim 13, further comprises a compensator in said reference light path.

24- The phase polarization imager according to claim 13, further comprises a CCD or CMOS image sensor in said analyzer light path,
